(19) United States
(12) Patent Application Publication
(10) Pub. No.: US 2023/0118269 A1
(43) Pub. Date: Apr. 20, 2023

(54) METHOD AND DEVICE FOR CURING A COATING, AND LAMINATE OBTAINED THEREWITH

(71) Applicant: Siegwerk Druckfarben AG & Co. KGaA, Siegburg (DE)

(72) Inventors: Thomas HAMMER, Howard Lake, MN (US); Kristian Paul WALSH, Newton, NC (US); Jaroslaw SLIWINSKI, Cape Coral, FL (US); Morris Dean RADFORD, Morganton, NC (US)

(21) Appl. No.: 17/501,171

(22) Filed: Oct. 14, 2021

(51) Int. Cl. B41M 7/00; C09D 11/101; B41M 5/52

(52) U.S. Cl. CPC B41M 7/0045; C09D 11/101; B41M 5/52

(57) ABSTRACT

The present invention is related to a method of curing a coated product comprising a substrate and a UV-curable coating composition applied onto a surface of said substrate, the method comprising the steps of transporting said coated product, by means of a web path, into a curing unit comprising a rotating unit, preferably a cylindrical body, and a treatment area formed between said rotating unit and said web path, said rotating unit and said web path having an even surface, wherein said coated product when being transported through said treatment area contacts the rotating unit and the web path so that no free areas between the coated product and the cylindrical body and the web path are present in said treatment area, and UV-curing said coated product present in said treatment area.

### FIELD OF THE INVENTION

The present invention is related to a method and device for curing a coating, and to a coated product obtained by said method and with said device.

### BACKGROUND OF THE INVENTION

For many applications where a high gloss and good resistance against environmental conditions is required, laminates are often the best choice.

According to the present invention, the term “laminate” refers to a product that consists of a stack of layers, wherein one layer (an outermost layer or a core layer) is defined as substrate or substrate layer. For example, the substrate layer may be a plastic layer.

Said substrate layer may be connected to another substrate layer, e.g. a printed paper substrate, via one or more additional layers, such as primer or adhesive layers.

Accordingly, a laminated product is a product where on a surface of one substrate, e.g. paper, a stack of layers is applied. Preferably, the other outermost layer of said stack of layers is also a substrate layer such as a plastic layer, preferably a transparent plastic layer.

By lamination, a product can be obtained that has excellent gloss and resistance characteristics.

As an alternative for protecting a surface of a substrate, applying a varnish onto said surface is known. Said varnish is typically a “liquid” coating that is cured after its application.

For example, said coating may be a UV-curable composition.

In recent years, radiation curable compositions (such as inks) have become increasingly popular. Radiation curable compositions are compositions which can be cured almost instantly when exposed to e.g. electromagnetic radiation in the ultraviolet region. Alternatively, curing of said compositions can also be performed using electron beams or LED technology. It is the rapid curing of these compositions which make them attractive for various applications.

Curing of radiation curable compositions predominantly proceeds via a radical polymerisation mechanism. Thus, the binder material of radiation curable compositions must comprise functional groups which are capable of undergoing such a radical curing mechanism. Typically, these functional groups are unsaturated moieties such as carbon-carbon double bonds, most commonly in the form of acrylate moieties. In UV curing compositions, a photoinitiator has to be present in order to evoke the radical polymerisation. Therefore, a typical radiation curable composition, preferably UV curable composition, comprises an acrylate containing material as a binder component and optionally a photoinitiator.

UV-curable compositions may be applied onto a surface of a substrate by a common printing process, such as for example flexographic printing, rotary screen printing, or offset printing.

After the UV-curable composition has been applied on the substrate, it is cured by irradiation with UV light in a respective curing unit.

While the gloss and resistance characteristics provided by a varnish may be very good, the ultimate target in terms of quality is the quality set by lamination. Said target is still difficult to achieve with a varnish applied on a substrate.

Typically, a UV-curable coating is cured in a curing station (that may be e.g. downstream of a printing unit), wherein said UV-curable coating is transported into said curing station by a printed substrate web and irradiated with one or more UV lamps, typically arranged at a distance above the web path. An example for such a curing unit is the UV conveyor 40 from Uvitron.

In US-2019/0225004 A1, a method for creating a label is described, wherein a preferably UV-curable coating is applied to a film and then embossed so as to provide a lens array. Embossing is achieved by positioning the film having the coating thereon around a cylinder that has been engraved with embossed images. The thus generated lens array is fixed by curing the coating while the coating is in contact with the embossed images on the engraved cylinder. It is suggested to utilize a clear engraved cylinder in which the UV lamp is positioned in the cylinder and cures through the cylinder where the coating is in contact with the outer surface of the cylinder.

Said document does not suggest a method of obtaining a varnished product that meets the quality standards set by laminates with respect to gloss and resistance. In said document, a lens array is provided through embossing with an engraved cylinder. Lens arrays have an uneven surface and thus do not exhibit high gloss.

It was the problem of the present invention to provide a method and device for manufacturing a varnished product that meets the quality standards set by laminates with respect to gloss and resistance.

### SUMMARY OF THE INVENTION

According to the present invention, said problem is solved by a method and device as defined in the appending claims.

In detail, the present invention is related to a method of curing a coated product comprising a substrate and a UV-curable coating composition applied onto a surface of said substrate, the method comprising the steps:

transporting said coated product, by means of a flexographic, rotary screen or offset printing onto a web path, into a curing unit comprising a rotating unit, preferably a cylindrical body, and a treatment area formed between said rotating unit and said web path, said rotating unit and said web path having an even surface, wherein said coated product when being transported through said treatment area contacts the rotating unit and the web path so that no free areas between the coated product and the rotating unit and the web path are present in said treatment area, and

UV-curing, preferably using at least one LED, said coated product present in said treatment area.

According to the present invention, it has been found that if the step of UV-curing is carried out in a treatment area where oxygen is essentially excluded, a higher degree of curing can be obtained due to the prevention of inhibitor of the curing reaction by oxygen. This results in a harder and thus more resilient respectively resistant coating.

This exclusion of oxygen from the treatment area, more specifically from the site therein where irradiation of the coated product with UV light (preferably from a LED) takes place, is achieved by providing said treatment area in a very limited space between a rotating unit, preferably a cylindrical body, and a coating on a web path. Said space has such dimensions that when a coated product (i.e. a product comprising a substrate and a liquid coating on a surface thereof) enters the treatment area, the coated product contacts the rotating unit and the web path so that no free areas between the coated product and the rotating unit and the coated product and the web path are present in said treatment area. Thus, any oxygen in the treatment area is displaced by the coated product entering into said treatment area.

According to a preferred embodiment, this can be achieved by tensioning the web path, with a commonly known tensioning device, to such an extent that the web path respectively a coated product positioned thereon is pressed against the rotating unit, preferably cylindrical body. Preferably, tensioning of the web path is conducted to such extent that the web path respectively a coated product positioned thereon is pressed against a segment of the circumferential surface of the rotating unit, preferably cylindrical body, that corresponds to 10-40%, preferably 20-30% of the entire circumferential surface of the rotating unit, preferably cylindrical body.

According to the present invention, the term “web” refers to any substrate (such as paper or film) in continuous roll form that is used in web-fed printers and web-based forms of printing such as flexography, gravure, and offset lithographic printing. According to the present invention, the term “web path” refers to the path on which a web is transported through a printing device during the printing process.

According to the present invention, the term “rotating unit” refers to a unit that can be rotated during the curing process. Preferably, this is a cylindrical body. In the alternative, also a belt can be used that can be subjected to a rotational movement.

According to a preferred embodiment of the present invention, the pressing of the web path respectively a coated product positioned thereon against a segment of the circumferential surface of the rotating unit is performed with the aid of a pressure roller that is added to the device to press the web path against the rotating unit to enhance the web tension in removing oxygen and making the coating smooth. Said pressure roller is preferably a vertically movable pressure roller having a surface opposite to the circumferential surface of the rotating unit, preferably cylindrical body, that has a form corresponding to the circumferential surface of the rotating unit, preferably cylindrical body. Said pressure roller is provided in the curing unit underneath the web path, over a length of the rotating unit, preferably cylindrical body, that corresponds at least to the size of the treatment area. When said pressure roller is moved so as to approach the rotating unit, preferably cylindrical body, it presses the web path respectively a coated product positioned thereon and located between the pressure and the rotating unit, preferably cylindrical body, against a segment of the circumferential surface of the rotating unit, preferably cylindrical body, that corresponds to 10-40%, preferably 20-30% of the entire circumferential surface of the rotating unit, preferably cylindrical body.

Said movement of said pressure roller is preferably vertically. Said movement may be achieved, for example, hydraulically, pneumatically, or with the use of a motor.

Said pressure roller may have any shape, provided that the surface opposite to the circumferential surface of the cylindrical body has a form corresponding to the circumferential surface of the rotating unit, preferably cylindrical body. Said pressure roller may be made of any suitable material, such as stainless or plastic material.

Moreover, the rotating unit, preferably cylindrical body, and the web path have an even surface. When the coated product enters the treatment area and contacts the rotating unit and the web path so that no free areas between the coated product and the rotating unit and the coated product and the web path are present in said treatment area, the surface of the liquid coating will also be smoothened. After curing, the resulting coating has a very even surface and thus provides for high gloss.

The cylindrical body being the preferred embodiment of the rotating unit may be a solid body or a tube having an inner space. According to a preferred embodiment of the present invention, said cylindrical body is a tube having an inner space, as will be discussed below. Said cylindrical body has an even outer surface.

According to the present invention, UV curing may be carried out with any light source capable of emitting UV light, such as a mercury lamp. It is preferred to use at least one LED as a light source. LEDs emitting UV light emit light having a wavelength in the range from 360 to 400 nm, preferably 380-395 nm.

The cylindrical body may be made of made of any suitable material, such as quartz glass or plastic material. However, according to a preferred embodiment of the present invention, said cylindrical body is made of a transparent material such as quartz glass that substantially lets pass through LED light of a wavelength in the range of 360-400 nm, preferably 380-395 nm. Substantially means here that 80-100%, preferably 85-95% of the LED light being irradiated through the cylindrical body passes said cylindrical body. The end faces of said cylindrical body may be made of non-transparent material, e.g. caps of stainless steel.

According to a preferred embodiment of the present invention, the inner space in the tube, representing the cylindrical body, has such a size that a UV lamp as conventionally used for UV-curing of UV-curable coatings, preferably a LED, may be inserted into said inner space. In order to minimize any loss of UV light when passing through the transparent tube, it is preferred to reduce the thickness of the wall of the transparent tube as much as possible. For example, the transparent tube may have a diameter from 100-300 mm, preferably 150-250 mm, and a wall thickness of 2-10 mm, preferably 2.5-5 mm.

In the inner space of said tube, if it does not have a size that matches the size of a UV lamp, preferably LED, fixing components for fixing the position of the UV lamp in the inner space are preferably provided, such as cubic support frame for taking up said lamp, wherein said support frame is fixedly attached to the inner surface of the wall of the tube. Preferably, a guiding means such as a slide may be provided with said fixing components for inserting and removing the UV lamp, preferably LED.

In the embodiment where the cylindrical body is a tube with an inner space, at least one, preferably one end face of said body is designed as a cap that can be removed from the cylindrical body in order to provide access to the inner space of said cylindrical body. The end cap may be fixed to the cylindrical body with commonly used fixation means, such as screws or clip locks. In an alternative embodiment of the present invention, the cylindrical body is a tube with an open end face, so that the UV lamp, preferably LED, can be easily positioned in and out of the cylindrical body.

The cylindrical body may be provided in a frame that supports the cylindrical body. That frame does not need to have any specific design, as long as it exhibits the functions described below. Preferably, the cylindrical body is attached to the frame by commonly used components that allow rotation of the cylindrical body. As an example, bearing blocks may be mentioned. Preferably, the cylindrical body is releasably attached to the frame so as to allow removal of the cylindrical body, for example for cleaning, maintenance or replacement purposes.

Thus, the frame preferably permits access to its interior at the side where the open or removable end face of the cylindrical body is located, so as to allow removal of the cylindrical body and/or the UV lamp, preferably LED, located in the inner space of the cylindrical body.

In the embodiment where a pressure roller as described above is additionally provided, said pressure roller is also arranged in the frame for supporting the cylindrical body. Said pressure roller may be fixed or removably attached to the frame, around the cylindrical body where the web path comes in contact with the cylindrical body.

According to a very preferred embodiment of the present invention, said UV-curing is performed with a UV lamp, preferably LED, that is provided in the interior of the cylindrical body, and said cylindrical body being permeable for UV radiation. This allows for excellent curing of the coated product, whereas UV light emitted from external UV lamps, preferably LEDs, may be deteriorated when the UV light emitted from those lamps has to pass the UV light through opaque components such as the substrate.

In the inner space of the cylindrical body, preferably electrical connections are provided for supplying the UV lamp, preferably LED, located therein with electricity. Preferably, said electrical connections are provided in an end face of the cylindrical body, more preferably in a removable end face.

If the frame is a closed body, in the side walls of the frame parallel to the axis of the cylindrical body openings are provided for allowing insertion and exiting of the web path and a coated product provided thereupon.

The curing unit comprises a treatment area. This is the area where a UV-curable coating is irradiated with UV light, preferably using a LED, in order to cure said coating. As described above, said treatment area is in the area between the rotating unit, preferably cylindrical body, and the web path.

Said space has such dimensions that when a coated product (i.e. a product comprising a substrate and a liquid coating on a surface thereof) enters the treatment area, the coated product contacts the rotating unit and the web path so that no free areas between the coated product and the rotating unit and the coated product and the web path are present in said treatment area. Thus, any oxygen in the treatment area is displaced by the coated product entering into said treatment area.

As described above, the width of the treatment area can preferably be adjusted by either tensioning the web path to the desired degree, or by pressing the web path and the coated product positioned thereon against the cylindrical body with the use of a suitable pressure roller.

According to the present invention, the treatment area extends over a segment of the circumferential surface of the rotating unit, preferably cylindrical body, that corresponds to 10-40%, preferably 20-30% of the entire circumferential surface of the rotating unit, preferably cylindrical body. Moreover, said treatment area extends over the length of the rotating unit, preferably cylindrical body, in axial direction of said rotating unit, preferably cylindrical body, at least to such an extent that the coated product positioned on the web path is fully within said treatment area when it is transported through the treatment area.

According to the present invention, curing in said treatment area formed between said cylindrical body and said web path can be conducted such that at the site of irradiation of the coated product with UV-light, preferably LED light, oxygen is present in an amount of less than 200 ppm, preferably less than 100 ppm and most preferably 0 ppm. Thus, the step of UV-curing is carried out at a site of said treatment area where oxygen is essentially excluded, so that a higher degree of curing can be obtained due to the prevention of inhibitor of the curing reaction by oxygen. This results in a harder and thus more resilient respectively resistant coating.

In addition, as will be discussed below, the amount of photoinitiator necessary for achieving sufficient curing of the UV-curable coating composition can be reduced, since there is no interfering oxygen present at the site of irradiation with UV light, preferably LED light.

According to the present invention, any conventionally used substrate for UV-coating may be used. For example, paper or various plastic films such as polyethylene films or polypropylene films may be mentioned.

Onto a surface of said substrate, a UV-curable coating composition is applied. The application of said UV-curable coating composition onto said substrate may be conducted with a conventional printing process, such as flexographic, rotary screen or offset printing. These processes are well-known and do not have to be explained here in detail.

According to a preferred embodiment of the present invention, said UV-curable coating composition is applied onto said surface of said substrate in a printing unit that is located in-line upstream said treatment area. Thus, according to this embodiment the steps of applying the UV-curable coating composition by a printing process and the subsequent curing step are performed in-line, i.e. in a continuous process without any interruption of the process.

A web path with rewind and unwind rollers may be provided for transporting the substrate into the printing unit, transporting the coated (uncured) product into the curing unit, and for transporting the cured product away from the curing unit. Preferably, only one web path is provided for all these steps, which then is the same web path that defines one boundary of the treatment area, as discussed above. The substrate is transported through the device at a speed of typically 100-1000 feet per minute (fpm), i.e. 0.51 to 5.1 m/s, preferably 200 to 400 fpm, i.e. 1.02-2.03 m/s.

The UV-curable composition of the present invention is designed to be cured by UV radiation, preferably LED radiation, and typically includes a binder comprising one or more oligomers and/or reactive monomers. Formulations are well-known and can be found in standard textbooks such as the Printing Ink Manual (Leach/Pierce (eds.), Blueprint, 5^{th} ed. 1993, e.g. p. 636 et seq.

Suitable oligomers (also referred to as prepolymers) include epoxy acrylates, acrylated oils, urethane acrylates, polyester acrylates, silicone acrylates, acrylated amines, acrylic saturated resins and acrylic acrylates. Further details and examples are given in the Printing Ink Manual (Leach/Pierce (eds.), Blueprint, 5th ed. 1993, e.g. p. 636 et seq.

Because of the high viscosity of most oligomers, diluents are typically required to reduce the overall viscosity of energy curing ink or coating formulation, so as to assist in handling and application. Suitable diluents may include water or “reactive” monomers which are incorporated into the cured film. Reactive monomers are typically acrylates or methacrylates, and can be monofunctional or multifunctional. Examples of multifunctional monomers would include polyester acrylates or methacrylates, polyol acrylates or methacrylates, and polyether acrylates or methacrylates. Further details and examples are given in the Printing Ink Manual cited above.

The UV-curable composition also comprises a photoinitiator. As photoinitiator, any commonly used photoinitiator in the field of printing inks and coating compositions may be used. As an example, acylphosphine oxides, such as 2,4,6-trimethylbenzoyldiphenylphosphine oxide, or the group consisting of acetophenone or benzophenone types of compounds may be mentioned, such as alkylbenzophenones, halomethylated benzophenones and 4,4′-bis(dimethylamino)benzophenone, and benzoin and benzoin ethers, such as ethylbenzoin ether, benzil ketals, such as benzil dimethyl ketal, acetophenone derivatives, such as hydroxy-2-methyl-1-phenylpropan-1-one and hydroxycyclohexyl phenyl ketone, may be mentioned.

The photoinitiators are preferably used in amounts of from 0.01 to 10% by weight, preferably 0.1 to 3% by weight, based on the polymerizable components. They can be used as individual substances or also in combination with one another. It is an advantage of the present invention that only low amounts of photoinitiator are required in the method of the present invention, due to the essential exclusion of oxygen from the treatment area described herein.

Additionally a photosensitizer may be added. The photosensitizer may be selected from the thioxanthone group of chemical compounds, for example isopropyl-thioxanthone (ITX), or 2,4-diethyl-thioxanthone (DETX), as well as mixtures thereof.

Optionally, the UV-curable composition may contain one or more fillers (also called extenders) in an amount of about 1-35% based on the weight of the finished ink. Suitable fillers include china clay, calcium carbonate, calcium sulphate, talc, silica, com starch, titanium dioxide, alumina and mixtures thereof.

The UV-curable composition may also contain about 1 to 5%, based on the weight of the finished ink, of a wax. Suitable waxes include carnauba waxes, montan waxes, polytetrafluoroethylene waxes, polyethylene waxes, Fischer-Tropsch waxes, silicone fluids and mixtures thereof.

Other additives may be incorporated in the UV-curable composition, including adhesive reagents, antifoaming reagents, leveling reagents, flow reagents, antioxidants, ultraviolet absorbers, flame retardants, etc.

With the method of the present invention, a product having specific characteristics can be obtained. Accordingly, the present invention is also related to a coated product comprising a substrate and a UV-cured coating composition applied onto a surface of said substrate that is obtained by the method described herein, and that preferably is characterized by improved gloss and resistance. As explained above, these improvements are obtained by transporting the uncured coated product through a specific treatment area where the surface of the UV-curable coating is smoothened (due to pressing it against the even surface of the rotating unit, preferably cylindrical body) and where curing proceeds essentially in the absence of oxygen.

According to a preferred embodiment, a coated product is obtained that has a gloss in the range of 80 to 120 degrees when measured on a BYK gloss meter at 60 degree angle.

According to another preferred embodiment, a coated product is obtained that has a rub resistance in the range of 500 to 1000 Sutherland rubs with 2 lb weight.

Gloss may be measured by placing a BYK Gloss Meter on the surface of the printed coating and taking a reading with the 60 degree setting. Rub resistance can be evaluated using a Sutherland Rub Testing device and usually face to face of the printed substrates rubbing with 2 or 4 lbs weight for any number of rub cycles. Other devices such as Taber device can also be used.

The present invention is also related to a device for performing a method as described herein, comprising a curing unit, wherein said curing unit comprises

a rotating unit, preferably a cylindrical body, and a web path, said rotating unit and said web path having an even surface,

a UV lamp, preferably a LED, and

a treatment area formed between said rotating unit and said web path.

As described above, the width of said treatment area can be adjusted so as to match the thickness of a UV-curable composition to be cured in said treatment area. The width of the web path is dictated by the printing plate on the press. The thickness of the coating applied is primarily dictated by the print process. In the case of flexography an anilox roller with certain line count and volume (described by BCM—billion cubic micron) will determine mostly the thickness of the coating applied. In UV chemistry, the thickness applied is also the thickness cured. The only other factor of thickness is how much is transferred from the anilox roller to the plate to the substrate and this can vary based on the applied chemistry, compatibility of materials (plates, substrate, etc.) and press speed.

As described above, the width of the treatment area can be adjusted by either tensioning the web path to the desired degree, or by pressing the web path and the coated product positioned thereon against the cylindrical body with the use of a suitable pressure roller.

As described above, preferably said UV lamp is provided in the interior of the rotating unit being a cylindrical body, and said cylindrical body is permeable for UV radiation. More preferably, said UV lamp is a LED lamp.

As described above, preferably said device further comprises a printing unit that is located in-line upstream said treatment area of said curing unit.

### BRIEF DESCRIPTION OF THE DRAWINGS

The present invention will now be explained below in more detail with reference to non-limiting drawings and examples.

FIG. 1 is a front view of an embodiment of a device with a curing unit according to the present invention

FIG. 2 is a side view of the embodiment of FIG. 1

FIG. 3 is a schematic representation of a device according to the present invention comprising a printing unit and a curing unit

FIG. 4 is a schematic representation of a coated product according to the present invention.

### DETAILED DESCRIPTION OF THE PREFERRED EMBODIMENTS

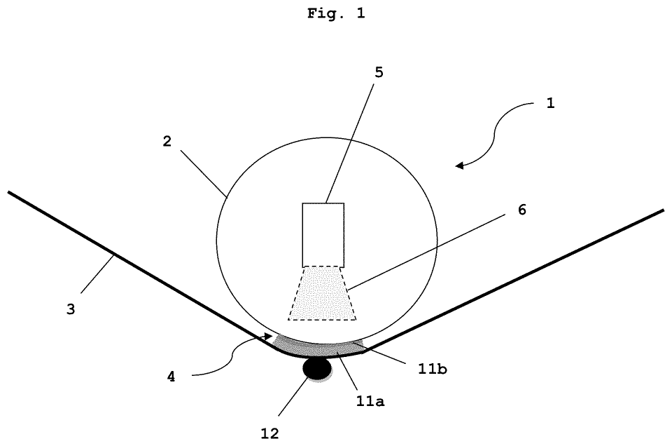

In FIG. 1, a front view of an embodiment of a device 1 with a curing unit according to the present invention is shown. Said curing unit comprises a cylindrical body 2 as a rotating unit, which here is transparent and hollow so that a LED serving as UV lamp 5 can be arranged within said cylindrical body 2.

A web path 3 transports a coated product 11 comprising a substrate 11a and a UV-curable coating 11b into a treatment area 4 between said cylindrical body 2 and said web path 3. In said treatment area 4, the coated product 11 is irradiated with LED light 6.

A pressure roller 12 is provided underneath the web path 3 in order to press the coated product 11 comprising a substrate 11a and a UV-curable coating 11b against the cylindrical body 2, thus reducing or completely eliminating the amount of oxygen in the treatment area 4.

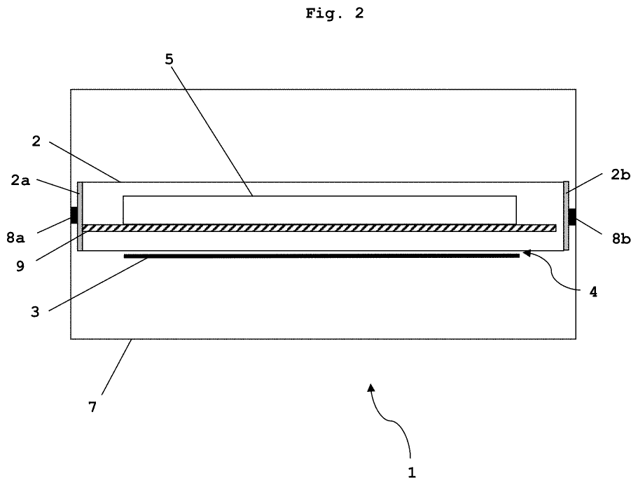

In FIG. 2, a side view of the embodiment of FIG. 1 is shown, wherein same reference numbers denote the same components.

In FIG. 2, the cylindrical body 2 is fastened to a frame 7 via bearings 8a, 8b that are connected with side faces 2a, 2b of said cylindrical body 2. Side face 2a is removable so as to allow access in the inner space of the cylindrical body 2. In said inner space, a support 9 in the form a slide for the LED light 5 is attached (by fixing means not shown).

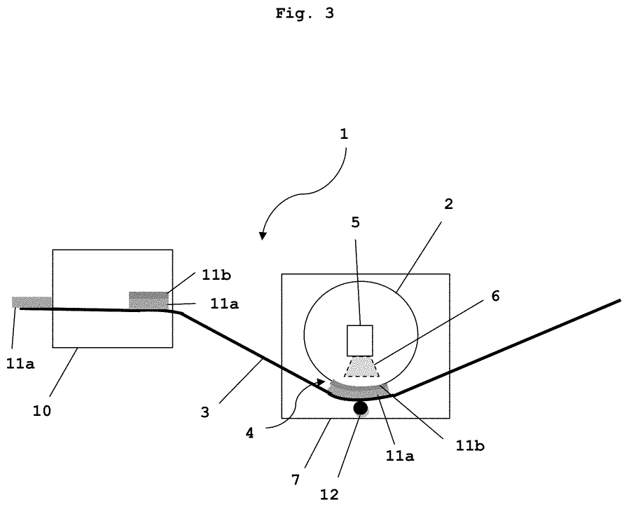

In FIG. 3, a schematic representation of a device 1 according to the present invention comprising a printing unit 10 and a curing unit is shown, wherein same reference numbers denote the same components.

In FIG. 3, a substrate 11a is transported by the web path 3 into the printing unit 10, where a UV-curable coating is applied. Then, the coated product 11 is transported in-line into the treatment area 4, where it is cured by LED light 6 from the UV lamp 5 provided within the cylindrical body 2.

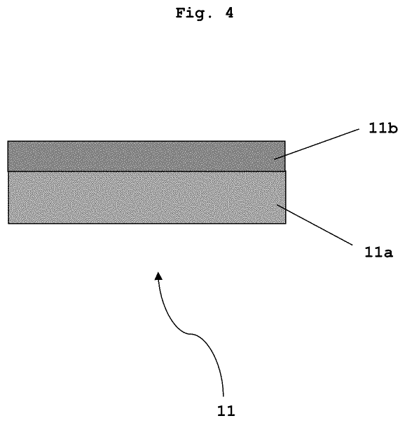

In FIG. 4, a schematic representation of a coated product 11 according to the present invention is shown, wherein same reference numbers denote the same components.

The coated product 11 consists of a substrate 11a and a UV-curable coating 11b applied to a surface of said substrate 11.

### Example 1

In a device as shown in example 1, a white polypropylene film was provided in a conventional printing unit (flexographic printing unit with a chamber system and an anilox roller of 400 lines/inch; 4.5 bcm) with a UV-curable coating, so that a coating layer was applied.

The coated PE film was conveyed, with a speed of 125 fpm, to a curing unit that comprised a cylinder made of quartz glass with a diameter of 200 mm and a wall thickness of 3 mm, and a LED lamp (Phoseon Firepower FP601 20 watt/cm² lamp) in said cylinder. Said LED lamp emitted UV light having a wavelength of 395 nm.

The coated PE film was pressed against the surface of the cylinder with the aid of a pressure roller (rubber roller with durometer hardness of 90) that was applied with a pressure of 60-100 psi) and a web tension of 56 psi against the uncoated surface of the PE film. Under this condition, the coated PE film was irradiated with UV light emitted from the LED in the interior of the cylinder with a power of 100%.

The resulting cured product was conveyed out of the curing area and evaluated for its gloss and rub resistance by the methods described herein. The obtained product had a gloss of about 100 degrees when measured on a BYK gloss meter at 60 degree angle, and a rub resistance of 500-1000 Sutherland rubs with 2 lb weight. Rub resistance was also measured with MEK rubs. MEK rub testing is performed with a 2 pound ball pen hammer with a cheese cloth on one end that previously immersed in MEK and then placed on the surface of the print. The hammer is pulled back and forth, thus allowing the weight of hammer to press against the printed surface with the MEK soaked cheese cloth. One rub is one back and forth movement of the hammer.

1. A method of curing a coated product comprising a substrate and a UV-curable coating composition applied onto a surface of said substrate, the method comprising the steps:
a) transporting said coated product, by means of a flexographic, rotary screen or offset printing onto a web path, into a curing unit comprising a rotating unit, preferably a cylindrical body, and a treatment area formed between said rotating unit and said web path, said rotating unit and said web path having an even surface, wherein said coated product when being transported through said treatment area contacts the rotating unit and the web path so that no free areas between the coated product and the rotating unit and the web path are present in said treatment area, and
b) UV-curing, preferably using at least one LED, said coated product present in said treatment area.

2. The method according to claim 1, wherein said UV-curing is performed with a UV lamp that is provided in the interior of the cylindrical body, and said cylindrical body being permeable for UV radiation.

3. The method according to claim 1, wherein said UV-curing is performed with a LED lamp.

4. The method according to claim 1, wherein said UV-curable coating composition comprises a photoinitiator in an amount from 0.01 to 10% by weight, preferably 0.1 to 3% by weight, of the entire amount of the UV-curable composition.

5. The method according to claim 1, wherein during step b) in said treatment area formed between said rotating unit and said web path, at the site of irradiation of the coated product with UV-light, oxygen is present in an amount of less than 200 ppm, preferably less than 100 ppm and most preferably 0 ppm.

6. The method according to claim 1, wherein said UV-curable coating composition is applied onto said surface of said substrate in a printing unit that is located in-line upstream said treatment area.

7. The method according to claim 1, wherein said coated product is transported through said treatment area with a speed of 100-1000 fpm, preferably 200 to 400 fpm.

8. The method according to claim 1, wherein said coated product is cured in step b) with LED light having a wavelength in the range from 360 to 400 nm, preferably 380-395 nm.

9. A product comprising a substrate and a UV-cured coating composition applied onto a surface of said substrate, obtainable by a method according to claim 1.

10. The product according to claim 9, wherein said product has a gloss in the range from 80 to 120 degrees when measured on a BYK gloss meter at 60 degree angle.

11. The product according to claim 9, wherein said product has a rub resistance in the range of 500 to 1000 Sutherland rubs with 2 lb weight.

12. A device for performing a method according to claim 1, comprising a curing unit, wherein said curing unit comprises a rotating unit, preferably a cylindrical body, and a web path, said rotating unit and said web path having an even surface,
a UV lamp, preferably LED, and
a treatment area formed between said rotating unit and said web path.

13. The device according to claim 12, wherein said UV lamp is provided in the interior of the cylindrical body, and said cylindrical body is permeable for UV radiation.

14. The device according to claim 12, wherein said UV lamp is a LED lamp.

15. The device according to claim 12, further comprising a printing unit that is located in-line upstream said treatment area of said curing unit.

16. The method according to claim 2, wherein said UV-curing is performed with a LED lamp.

17. The product according to claim 10, wherein said product has a rub resistance in the range of 500 to 1000 Sutherland rubs with 2 lb weight.

18. The device according to claim 13, wherein said UV lamp is a LED lamp.
